(19) United States
(12) Patent Application Publication
(10) Pub. No.: US 2026/0044679 A1
(43) Pub. Date: Feb. 12, 2026

(54) MINIMIZING CONTEXT FOR LARGE LANGUAGE MODEL FUNCTION CALLING

(71) Applicant: Cisco Technology, Inc., San Jose, CA (US)

(72) Inventors: Fergal Keating, Carlow (IE); Andrew McGlynn, Kiltullagh (IE); Ciaran Raymond Jordan, Newcastle (IE); Mark Stanford, Galway (IE)

(21) Appl. No.: 18/796,606

(22) Filed: Aug. 7, 2024

(51) Int. Cl. G06F 40/35

(52) U.S. Cl. CPC G06F 40/35

(57) ABSTRACT

Provided herein are techniques to facilitate minimizing context for LLM function calling operations. In one example, a method may include obtaining, by an interface system, a user conversation input; providing, to an LLM, for each of one or more interactions between the interface system and the LLM: a description of the interface system; the user conversation input; a list of function groups that describes types of functions that the interface system is capable of performing; and a list of private functions that are callable by the LLM, based on the user conversation input, to receive function context from the interface system or to cause function operations to be performed by the interface system; and providing one or more user conversation outputs based on at least one of the one or more interactions by the interface system with the LLM.

### TECHNICAL FIELD

The present disclosure relates to network equipment and services for interfacing with Large Language Models (LLMs).

### BACKGROUND

Function calling is a useful feature for utilizing a Large Language Model (LLM) in which the LLM can classify an intent (of a user interacting with the LLM) and inform a system to invoke a function based on certain input data. Function calling for an LLM typically involves sending a complete function list and also a complete conversation history to the LLM for each interaction with the LLM, due to LLMs being stateless. However, the use of large function lists combined with a lengthy conversation history for interactions with an LLM can easily consume the token budget for the LLM, which can result in errors being returned by the LLM or can cause the LLM to hallucinate. Thus, there are significant challenges with regard to utilizing an LLM for function calling.

### BRIEF DESCRIPTION OF THE DRAWINGS

FIG. 1 is a block diagram of a system that can be implemented to facilitate minimizing context for Large Language Model (LLM) function calling interactions, according to an example embodiment.

FIG. 2 illustrates a nested tree structure that can be utilized to configure the function groups for context interface system, according to an example embodiment.

FIGS. 3A, 3B, 3C, 3D, and 3E are a message sequence diagram illustrating example operations that can be performed to minimize context for LLM function calling operations, according to an example embodiment.

FIG. 4 is a block diagram illustrating example details of function groups, functions, and data that can be configured and/or maintained/stored by the context interface system of FIG. 1, according to an example embodiment.

FIG. 5 is a flow chart depicting a method according to an example embodiment.

FIG. 6 illustrates a hardware block diagram of a computing device configured to perform functions associated with operations discussed in connection with embodiments herein.

### DETAILED DESCRIPTION

### Overview

In at least one embodiment, a computer-implemented method is provided that may facilitate minimizing context for LLM function calling operations. In one form, a computer-implemented method is provided that may include obtaining, by an interface system, a user conversation input; providing, to an LLM, for each of one or more interactions between the interface system and the LLM: a description of the interface system; the user conversation input; a list of function groups that describes types of functions that the interface system is capable of performing; and a list of private functions that are callable by the LLM, based on the user conversation input, to receive function context from the interface system or to cause function operations to be performed by the interface system; and providing one or more user conversation outputs based on at least one of the one or more interactions by the interface system with the LLM.

### EXAMPLE EMBODIMENTS

In a Large Language Model (LLM) environment, function calling can be a useful feature through which an LLM can classify an intent and inform a consumer to invoke a function based on certain input data. Utilizing a function calling facility through an LLM, such as through a user via a user device seeking to invoke a function via an LLM, typically involves sending or passing to the LLM a complete list of functions that can be invoked by the LLM along with a full chat/conversation history to the LLM for each interaction (also referred to herein as ‘prompt interaction’] with the LLM, due to LLMs being stateless.

Complex systems can have many settings and controls. Providing an LLM interface to a complex system can involve utilizing a particular function for each setting or control of the system. Large function lists, combined with a lengthy chat history, can easily consume the entire token budget for an LLM. This can result in errors being returned by the LLM or causing the LLM to hallucinate.

For example, the chat history for a user conversation with an LLM can grow quite fast and can cause the token limit for the LLM to exceed a hallucination/error boundary. With the addition of a large set of available functions that can be invoked by the LLM, token utilization by the LLM is further increased and the hallucination boundary can be exceeded even faster.

In some instances, it may be possible to utilize prompt engineering (e.g., developing specific LLM inputs or “prompts” designed to trigger specific responses/function calls to be invoked by an LLM) and chat history summarization techniques to limit the amount of information sent an LLM and, thus, limit token count for the LLM. However, such techniques typically do not scale, given LLM token count limitations and risks of hallucination.

To address such issues/limitations, embodiments herein provide for the ability to implement a function context engine, referred to herein as a ‘context interface system’, that can be utilized as an intermediary with an LLM to minimize token usage for each interaction with the LLM, thus reducing token usage cost and errors, while still supporting a large set of capabilities/functions that can be invoked/utilized by an LLM to perform operations based on various user conversation inputs, also referred to interchangeably herein as ‘user prompts’.

Stated differently, embodiments herein provide an architecture that facilitates reducing/erasing issues with consuming the entire token budget of an LLM and/or causing the LLM to hallucinate by replacing the simple, static function list that an ‘out-of-the-box’ LLM typically supports with a context interface system that, among other features as discussed for embodiments herein, provides for reducing the number of functions that are passed to an LLM for each interaction (prompt interaction) with the LLM. This may have an effect of increasing the number of functions that the LLM can classify for a system and reducing the overall token size in each interaction with the LLM, while maintaining a simple and accurate end user experience.

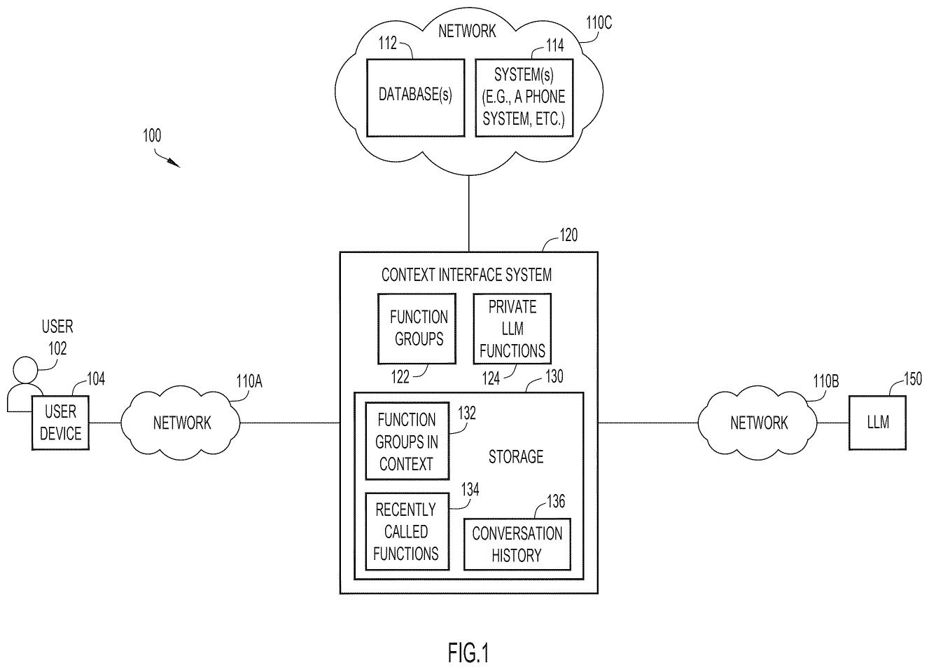

Referring to FIG. 1, FIG. 1 is a block diagram of a system 100 that may be implemented to facilitate minimizing context for Large Language Model (LLM) function calling interactions, according to an example embodiment. In at least one embodiment, system 100 may include a context interface system 120 and an LLM 150. Also shown in FIG. 1 are a user 102 that can operate a user device 104 in which the user device may interface with the context interface system 120 via a network 110A and the context interface system 120 can further interface with the LLM 150 via a network 110B.

The context interface system 120 can also interface with one or more other networks, such as a network 110C, that may include one or more databases 112 and/or one or more systems 114 with which the context interface system 120 can interact, perform one or more operations (e.g., based on user conversation inputs (user prompts) provided by the user 102/user device 104, based on one of more functions invoked by the LLM 150, etc.), manage, and/or the like in accordance with embodiments herein.

The context interface system 120 may be configured with a number of function groups 122 and a number of private LLM functions 124. The context interface system 100 may also be configured with storage 130, that can be used to store various data/information utilized for various operations of system 100, such as metadata/information associated with function groups in-context, recently called functions, and a conversation history for each of one or more user conversations that can be facilitated by the context interface system 120 for one or more users.

Generally, LLM 150 may represent any model that is capable of learning general representations of the word that can be adapted to a wide range of downstream tasks, operations, etc. During operation of system 100, the LLM 150 may receive a natural language instruction or prompt that may include a number of prompt segments, such as a user 102 conversation input and other prompt segments, that can be provided or passed by context interface system 120 to the LLM 150, as discussed in further detail herein, such that the LLM can process the information obtained from the context interface system 120 to extract and interpret various actions to be performed.

Generally, user device 104 may be any computing device (e.g., laptop, desktop computer, etc.), mobile device (e.g., smart phone, tablet, etc.), cloud device (e.g., web portal/interface, etc.), logic, application, combinations thereof, and/or the like with which the user 102 may interact to provide one or more user conversation inputs, which may be provided using any combination of input devices (e.g., keyboard, touchpad, microphone, etc.) and obtain one or more user conversation outputs via any combination of output devices (e.g., screen, speaker, etc.) for one or more interactions with context interface system 120 and LLM 150.

The context interface system 120 may include several features that provide for maximizing the number of capabilities that the system support and maintain a simple conversation flow, while minimizing the exchange of unnecessary data with the LLM 150, which can incur financial costs and/or increase errors in calling functions (e.g., hallucinations, etc.).

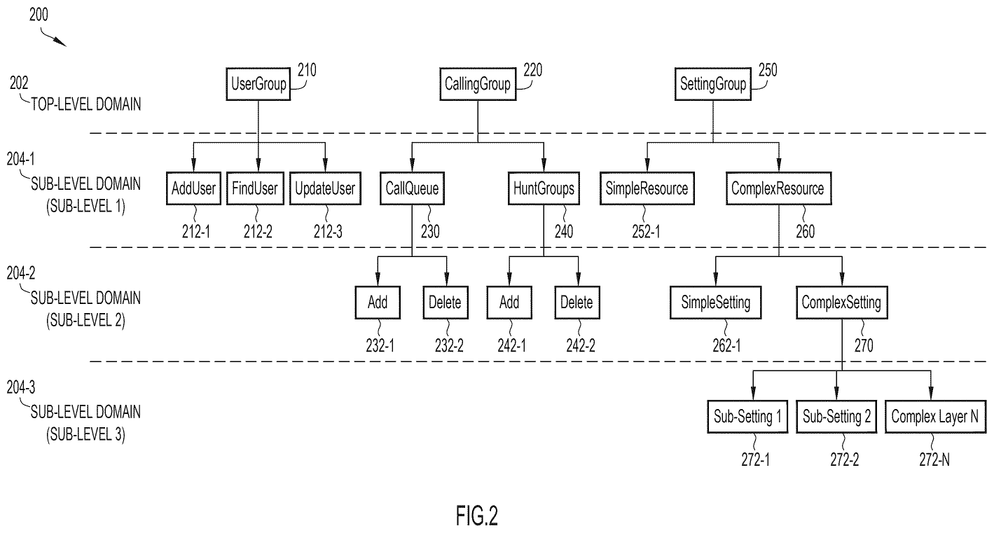

For example, the function groups 122 may be configured to include different types or classes of available functions that the context interface system 120 is capable of performing and that can be invoked by the LLM 150 based on various user 102 conversation inputs (e.g., provided via user device 104) in order to cause the context interface system 120 to perform one or more operations. Broadly, function groups and function(s) within each function group may be characterized as ‘end user functionality’ or, stated differently, functions/corresponding operations that may be invoked via the context interface system 120 by the LLM 150 based on various user conversation inputs in which the functions/operations can be performed by the context interface system 120 via any combination of database(s) 112 and/or system(s) 114 with which the context interface system 120 further interfaces/interacts. Additional example details regarding various function groups 122 that may be configured for the context interface system 120 for an example scenario in which the context interface system 120 further interfaces with a phone system that can be managed, operated, etc. via the context interface system 120 are discussed below with reference to FIGS. 2, 3A, 3B, 3C, 3D, 3E, and 4.

The private LLM functions 124 may be configured as LLM-specific functions that are callable by the LLM 150, based on various user 102 conversation inputs, in order to receive function context from the context interface system 120 for a corresponding function group, to cause function operations to be performed by the context interface system 120 for a corresponding function, and/or to otherwise privately call towards the context interface system 120 to trigger any other operations/actions to be performed by the context interface system 120. Additional example details regarding various private LLM functions that may be configured for context interface system 120 for the phone system operational example are discussed below with reference to FIGS. 2, 3A, 3B, 3C, 3D, 3E, and 4.

Broadly, the context interface system 120 may operate to reduce the amount of information passed to the LLM 150 over a user conversation (e.g., involving user 102/user device 104) while retaining important context of the user conversation in order to facilitate various function calls to be invoked by the LLM 150, via the context interface system 120, based on the user conversation.

For example, the context interface system 120 may operate to reduce the number of functions and corresponding function information that is passed to an LLM in order to increase the total number of functions usable by the context interface system 120. This can be achieved with function groups 122 in which each function group configured for the context interface system 120 contains a list of functions in which each function may be considered a capability of the context interface system 120 or another sub-function group of a particular function group. The use of function groups 122 allows the context interface system 120 to utilize the LLM 150 as a call-back mechanism to identify which functions or function group are to be invoked based on user conversation input(s).

Further, the private LLM functions 124 can provide a set of callable functions that can be utilized by the LLM 150 to receive function context from the context interface system 120 for a corresponding function group, to cause function operations to be performed by the context interface system 120 for a corresponding function, and/or to otherwise privately call towards the context interface system 120 to trigger any other operations/actions to be performed by the context interface system 120.

Through storage 130, the context interface system 120 can retain metadata/information regarding particular function group(s) that that are ‘in-context’ or, stated differently, are the current focus of a given user conversation, shown in FIG. 1, as ‘function groups in-context’ 132. This retained knowledge of the context interface system 100 allows a minimum set of function data/information to be passed to the LLM 150 based on the current context of a user conversation such that function group(s) that may be considered ‘in-context’ can be dynamic and can be swapped/updates as the context of a user conversation changes.

Further, the storage 130 can be used by the context interface system 120 to retain metadata/information regarding recently called functions (i.e., functions recently called by the LLM 150 for context interface system 120), shown in FIG. 1 as ‘recently called functions’ 134. Such recently called functions metadata/information may provide for the ability to easily undo or redo (e.g., with new data) one or more user requests with minimal LLM 150 interactions.

Additionally, the storage 130 can be used by the context interface system 120 to retain knowledge/information (labeled 136 in FIG. 1) regarding the conversation history involving a user conversation between function calls based on the user conversation. In some instances, the conversation history can be summarized.

During operation of system 100, the user 102 may input a natural language user prompt (user conversation input) to user device 104, such as a question, for example “Can you update user information?” which can be communicated to the context interface system 120.

To minimize context for the LLM 150 for interactions between the context interface system 120 and the LLM 150, context interface system 120 can pass a core set of prompt segments to the LLM 150 for each interaction (prompt interaction) with the LLM 150. Based on one or more private function calls that may be initiated by the LLM 150 towards the context interface system 120, one or more additional prompt segments may be passed to the LLM 150, in addition to the core set of prompt segments that are passed to the LLM 150 for each interaction.

The core set of prompt segments that can be passed by the context interface system 120 to the LLM 150 on each interaction with the LLM 150 can include:
1) a user conversation input (user prompt) prompt segment, referred to herein using the nomenclature ‘[user conversation]’;
2) a predefined or ‘pre-engineered’ prompt segment that provides the LLM 150 with a description of the context interface system 120 and capabilities thereof, referred to herein using the nomenclature ‘[predefined prompt]’;
3) a ‘function groups and descriptions’ prompt segment that includes a list of top-level function groups and identifies/describes what types of functions the context interface system 120 is capable of performing for each of the top-level function groups, referred to herein using the nomenclature ‘[function groups]’; and
4) a ‘private LLM functions’ prompt segment that includes a list of private functions that are callable by the LLM 150 in order to obtain (additional) function context from the context interface system 120, to set a function group as ‘in-context’, to invoke a function via the context interface system 120, and/or to perform a variety of other operations via the context interface system; referred to herein using the nomenclature ‘[private LLM functions]’.
   The order of the core set of predefined prompts sent to the LLM 150 can be varied in accordance with embodiments herein.

The [user conversation] prompt segment that is passed to the LLM 150 can be updated/changed depending on user conversation inputs while each of the [predefined prompt] prompt segment, the [function groups] prompt segment, and the [private LLM functions] prompt segment remain static and do not change each time that they are passed to the LLM 150.

In addition to the core set of prompt segments, various other prompt segments can be sent/passed to the LLM 150 by the context interface system 120 (and may be dynamic/modified for different interactions) based on user conversation inputs and/or one or more private LLM functions that may be called by the LLM 150 towards the context interface system 120. The other prompt segments that can be sent to the LLM 150 in addition to the core prompt segments are discussed in further detail herein below, with reference at least to TABLE 1.

In this manner, the context interface system 120 is to determine the prompt segments (and corresponding information) that are to be sent to the LLM 150 for each interaction with the LLM 150, while reducing the number of tokens being used in cases where many functions can be called by the LLM 150, and conversations may be tracked with users over long time periods.

Before discussing other example details for various prompt segments that the context interface system 120 can send/pass to the LLM 150 for each interaction with the LLM 150, consider additional example details for function groups 122 that can be configured for context interface system 120 and how they may be utilized by the context interface system 120 to minimize context for the LLM 150, as discussed with reference to FIG. 2, for a particular operational example in which the context interface system may interface/interact with a phone system that can be managed, operated, etc. by user 102/user device 104 via the context interface system 120.

For example, with reference to FIG. 2, FIG. 2 illustrates a nested tree structure 200 that can be utilized to configure the function groups 122 for context interface system 120, according to an example embodiment. As shown in FIG. 2, the nested tree structure 200 may include a top-level domain 202 and a number of sub-level domains, shown in FIG. 2A as a sub-level domain 204-1 (sub-level 1), a sub-level domain 204-2 (sub-level 2), and a sub-level domain 204-3 (sub-level 3).

It is to be understood that the nested tree structure 200 for the function groups 122, as illustrated in FIG. 2, is provided for illustrative purposes only and is not meant to limit the broad scope of embodiments herein. For example, any ‘N’ number of sub-level domains can be configured for function groups configured for a context interface system.

For the nested tree structure 200 of the function groups 122, each node in the structure may either be a terminating function, which is a function that can be invoked/called by the LLM 150 via the context interface system 120, or a function/sub-function group. The structure can be hierarchical such that the function groups/terminating functions can become more specialized as branches of each function group traverse deeper into the structure.

Each function group and each sub-function group can be configured with a function group/sub-function group identifier or name, referred to herein as ‘FunctionGroupName’, which may be any alphanumeric character string, value, combinations thereof, and/or the like, which can be used by context interface system 120 to identify a corresponding function group/function sub-function group for various interactions between the context interface system and the LLM 150, in accordance with embodiments herein.

The terms ‘terminating function’ and ‘function’ (of function group/sub-function group) can be referred to herein interchangeably. Each terminating function/function of a given function group/sub-function group can be configured with a function identifier (FunctionID), which may be any alphanumeric character string, value, combinations thereof, and/or the like, which can be used by context interface system 120 to identify a corresponding terminating function/function that may be invoked/called by LLM 150, in accordance with embodiments herein.

Consider for the present operational example in which the context interface system may interface/interact with the phone system that three top-level function groups are provided, such as a UserGroup 210 that may be associated with user management functions/operations that can be performed via the context interface system 120 based on various user prompts (conversation inputs), a CallingGroup 220 that may be associated with calling functions/operations that can be performed via the context interface system 120 based on various user prompts, and a SettingGroup 250 that may be associated with configuration/management functions/operations that can be performed for settings of the application (the phone system application) via the context interface system 120 based on various user prompts.

Sub-level domain 204-1 of the UserGroup 210 may include a number of terminating functions for managing users of the phone system, such as an AddUser function 212-1, a FindUser function 212-2, and an UpdateUser function 212-3.

CallingGroup 220 illustrates a scenario in which sub-level domain 204-1 of the CallingGroup 220 may further be configured with a number of sub-function groups (e.g., for performing/making various phone calls using the phone system), including a CallQueue sub-function group 230 and a HuntGroups sub-function group 240, each of which may include different terminating functions, as illustrated for sub-level domain 204-2. For example, the CallQueue sub-function group 230 may include a number of terminating functions, such as an Add function 232-1 and a Delete function 232-2, and the HuntGroups sub-function group 240 may also include a number of terminating functions, such as an Add function 242-1 and a Delete function 242-2.

Further, SettingGroup 250 illustrates a more advanced scenario in which a combination of terminating functions and sub-function groups can organized among the various sub-domain levels in order to facilitate performing various phone system settings related functions (e.g., for setting/configuring different settings for the phone system). Features of the SettingGroup 250, illustrate generic patterns that can be suitable for many domains, dependent on use case. For example, resources such as a terminating function/function be characterized as simple resources and resources such as function groups can be characterized as complex resources to be managed. For example, sub-level domain 204-1 may identify a terminating function for managing a simple resource via a SimpleResource function 252-1 and may also identify a sub-function group for managing a more complex resource via a ComplexResource sub-function group 260.

A more complex resource may involve additional operations/functions to be performed in order to facilitate managing/configuring the more complex resource via a SimpleSetting 262-1 function configured at the sub-level domain 204-2 that can be invoked to manage/configure the complex resource. However, a ComplexSetting 270 sub-function group configured for the sub-level domain 204-2 can include various terminating functions at the sub-level domain 204-3 that can be used to manage/update a more complex setting. For example, a Sub-Setting1 function 272-1 can be used to manage/update a first sub-setting of the complex setting, a Sub-Setting2 function 272-2 can be used to manage/update a second sub-setting, and so on through a number of sub-settings/Sub-SettingN functions 272-N.

Within the context of various settings that could be provided for a phone system, settings could include a sub-function group such as Branding settings at 260 that could correspond to branding settings (e.g., for controlling the look and feel of end user clients) and SimpleSetting 262-1 could be a terminating function for enabling/disabling custom branding. An additional sub-function group of Branding could further be configured via ComplexSetting 270, and so forth for any tree of terminating functions/sub-function groups. Accordingly, any variation of terminating function(s) and/or sub-function group(s) could be configured for a nested tree structure that may be configured for a given context interface system in accordance with embodiments herein.

During operation of system 100, a single prompt from the user 102, can result in multiple interactions between the context interface system 120 and the LLM 150, where the domain of the nested tree structure for the function groups 122 and function list(s) become more specialized until an appropriate/correct function is identified to be invoked via the context interface system 120. Although traversing the nested tree structure for the function groups 122 may involve multiple interactions for a giver user prompt, the token size of each interaction is reduced and the LLM 150 can identify the correct the correct function without the risk of hallucinating. The number of functions passed to the LLM 150 can be drastically reduced since the top-level domain (e.g., 202) is known by the context interface system 120, and it can dynamically load/pass the appropriate/correct functions sought to be invoked by the LLM 150, when needed, or, stated differently, when requested by the LLM 150 or set to be ‘in-context’ by the LLM 150 (e.g., through one or more private LLM function calls sent by the LLM 150 to the context interface system 120).

For example, with more complex systems the number of functions can increase drastically, which can impact the size of the data passed to the LLM 150 in each interaction with the LLM 150. As shown in FIG. 2, the total number of nodes in FIG. 2 is 19 nodes. If a non-hierarchical approach were used for interacting with the LLM 150, data for all 19 nodes would need to be sent to the LLM 150 for each interaction with the LLM 150, which would unnecessarily consume tokens of the LLM 150.

However, by providing for the ability to provide data for a reduced set of nodes to the LLM 150, namely, data for the three top-level function groups (UserGroup, CallingGroup, and SettingGroup) that describe broad capabilities of functions that context interface system 120 is capable of performing, the hierarchical tree structure 200 of the function groups 122 can be used to reduce the number of tokens consumed for each interaction with the LLM 150.

Specifically, specific function(s)/sub-function group(s) that may be configured for a particular function group/sub-function group are not passed to the LLM 150 as part of the core set of prompt segments sent to the LLM 150 for each interaction with the LLM 150. Rather, specific function(s)/sub-function group(s) of a particular function group/sub-function group are only sent to the LLM 150 when requested/queried by the LLM, which can help to minimize context (token usage) by the LLM 150. Through the use of certain private LLM function calls (discussed in further detail below), the LLM 150 can still obtain additional function context from the context interface system 120 for a corresponding function group/sub-function group when needed, for example, based on user conversation inputs (e.g., the user perhaps seeking to update user information, to update a setting, etc.).

TABLE 1, below, illustrates various prompt segment example details for different prompt segments that can be sent/passed by the context interface system 120 to the LLM 150 and when each prompt segment is to be sent to the 150 for various interactions with the LLM 150. For the prompt segment example details illustrated/discussed with reference to TABLE 1, consider that the example details are provided with reference to a particular operational example in which the context interface system 120 is utilized to interface/interact with a phone system that can be managed by user 102/user device 104 via the context interface system 120 and LLM 150.

TABLE 1
PROMPT SEGMENT EXAMPLE DETAILS

| PROMPT SEGMENT | DESCRIPTION | CONTENT EXAMPLES |
|---|---|---|
| Predefined Prompt | Sent every prompt/interaction. | “You are talking to with user who |
| | (Static) | is seeking to call specific |
| | This is a pre-engineered prompt | functions. You will need to |
| | segment gives the LLM context | determine a function to call and |
| | that the LLM is talking to a | call it for the user based on a user |
| | user/customer who is utilizing a | prompt. The application the user |
| | system that can call system- | is managing is a phone system |
| | specific functions. The prompt | that can be configured, used, |
| | segment can also be used to | managed, etc.” |
| | inform the LLM of the existence | |
| | of private LLM functions that | |
| | are available to the LLM (e.g., to | |
| | obtain more context for a | |
| | function group, to call a | |
| | particular function, etc.) | |
| Function Groups | Sent every prompt/interaction. | {“FunctionGroups”: |
| | (Static) | [ |
| | This informs the LLM of each | {“1”: “UserGroup”, |
| | top-level domain function group | “description” : “functions |
| | configured for the context | for managing users of the |
| | interface system and provides | system”}, |
| | the LLM with general details on | {“2”: “CallingGroup”, |
| | what groups of functions are | “description” : “functions |
| | available to the LLM (for the | for calling and viewing calling |
| | top-level domain). | data”}, |
| | | {“3”: “SettingGroup”, |
| | | “description” : “functions for |
| | | configuring the application”} |
| | | ] |
| | | } |
| Private LLM | Sent every prompt/interaction. | A similar format as provided for |
| Functions | (Static) | the [function groups] prompt |
| | This informs the LLM of private | segment can be used to describe |
| | functions that are callable by the | the private LLM functions. |
| | LLM towards the context | |
| | interface system to: obtain | |
| | (additional) function context | |
| | from the context interface | |
| | system, to set a function group | |
| | as ‘in-context’, to trigger various | |
| | function operations to be | |
| | performed by the context | |
| | interface system, and/or to cause | |
| | any other action/operation/etc. | |
| | by the context interface system | |
| | (e.g., send a user | |
| | response/content, identify a | |
| | function called as a user-facing | |
| | function, etc.). | |
| User Conversation | Sent every prompt/interaction | “Please update the user Fergal to |
| | but cleared. | Fearghal” |
| | (Dynamic, depending on user | |
| | conversation inputs) | |
| | The user conversation is | |
| | assumed to be a user looking to | |
| | call a function. Once that | |
| | function is called, it is added to | |
| | recently called functions and the | |
| | current chat/conversation history | |
| | is cleared by the context | |
| | interface system. | |
| In-Context Functions | Sent when in-context. | { |
| | If the LLM determines that a | “UserGroup”: |
| | specific function group is | [ |
| | needed, then this group can be | {“1”: “AddUser”, |
| | marked as ‘in-context’ (using a | “description” : “manage |
| | private LLM function call | users of the system”, |
| | towards the context interface | “parameters” : “name, |
| | system) and ‘in-context’ | email” |
| | functions for the group (and their | }, |
| | corresponding descriptions) can | {“2”: “FindUser”, |
| | be passed to the LLM. In- | “description” : “find a user |
| | context functions can also be | by their name”, |
| | passed to the LLM if | “parameters” : “name”}, |
| | information for a given function | {“3”: “UpdateUser”, |
| | group is queried by the LLM. | “description” : “Update |
| | (e.g., when a user or the LLM | users name”, |
| | 150 asks about user-related | “parameters” : “name, |
| | functions, then the functions of | newname”} |
| | the UserGroup can be added as a | ] |
| | prompt segment | } |
| | [UserGroupFunctions] that can | |
| | be passed to the LLM, | |
| | describing terminating functions | |
| | identified in sub-level 1 of the | |
| | UserGroup top-level function | |
| | group). Other prompt segments | |
| | for other function groups passed | |
| | to the LLM 150 as in-context | |
| | can be formatted in a similar | |
| | manner, for example, | |
| | [NameGroupFunctions] for any | |
| | function group ‘Name’. | |
| Private Function Call | Sent after an LLM has | You (the LLM) have just called |
| Response | performed a private function call | the following function: |
| | towards the context interface | { |
| | system. | “function”: “FindUser”, |
| | The LLM has decided it needs | “description” : “find a user by |
| | more information to complete an | name”, |
| | action and can call a function (of | “parameters” : “name=Fergal”} |
| | a function group) privately. A | and received the following |
| | result of the private function call | response: |
| | is included in responses/ | { |
| | interactions with the LLM until | User: |
| | the current user conversation is | { |
| | cleared for the context interface | Id: 1 |
| | system (e.g., the context | Name: Fergal |
| | interface system determines that | } |
| | a user-facing function, such as a | } |
| | function that is determined (by | |
| | the LLM) to perform a particular | |
| | action operation originally | |
| | sought by the user has been | |
| | invoked.) | |
| Recently Called | Sent following the invocation of | The Following shows recently |
| Functions | a user-facing function. | called functions and their |
| | These are user-facing functions | responses that may be useful for |
| | that have been recently invoked | context. |
| | by the LLM toward the context | { |
| | interface system to perform | ″function″: ″findUser″, |
| | actions/operations originally | ″parameters″ : |
| | sought by the user/user | ″name=fergal″ |
| | conversation. Sending recently | “response: { |
| | called functions to the LLM | User: { |
| | allows the chat history to be | Id: 1 |
| | cleared by the context interface | Name: Fergal |
| | system after a user-facing | } |
| | function has been invoked, while | } |
| | allowing natural calling of Undo | } |
| | and Redo functionality. | { |
| | | ″function″: ″UpdateUser″, |
| | | ″parameters″ : ″id=1, |
| | | newname=fearghal″ |
| | | } |

Before discussion various operations that may be performed for various interactions between context interface system 120 and the LLM 150, consider various example details of various private LLM functions that can be configured for the context interface system 120 to be called by the LLM 150 during the operation of system 100, in accordance with embodiments herein.

One private LLM function that can be configured for the context interface system 120 can include a function that the LLM 150 can call in order to obtain from the context interface system 120 data/information (context) regarding any function groups and/or sub-function groups (included on a given sub-level domain for a particular function group/sub-function group), referred to herein as a ‘GetGroupFunctions(FunctionGroupName)’ function in which a name of a corresponding function group can be input to the private LLM function call by the LLM 150 in order to obtain corresponding data/information for the corresponding function group. Thus, the GetGroupFunctions(FunctionGroupName) function may be characterized as a query function that enabled the LLM 150 obtain from the context interface system 120 additional function context for a corresponding function/sub-function group (e.g., function(s)/sub-function group(s) thereof).

Another private LLM function may include a function that the LLM 150 can call in order to obtain from the context interface system 120 data/information (context) regarding any recently called functions that have been recently called by the LLM 150, referred to herein as a ‘GetRecentlyCalledFunctions( )’ function.

Another private LLM function may include a function that the LLM 150 can call to trigger the context interface system 120 to set a particular function group as ‘in-context’, referred to herein as a ‘SetFunctionGroupInContext(FunctionGroupName)’ function, in which a name of a corresponding function group can be input to the private LLM function call by the LLM 150 in order to set the corresponding function group as ‘in-context’ for a given user conversation/conversation input.

Yet another private LLM function may include a function that the LLM 150 can call to privately invoke/call a function (terminating function) of a particular function group/sub-function group (i.e., that is in-context) for a corresponding user conversation, referred to herein as a ‘CallFunctionPrivately(FunctionID)’ in which the FunctionID can be set to the identifier for the function called by the LLM 150.

Other private LLM functions may be configured for the context interface system 120 in accordance with embodiments herein. For example, in some embodiments the LLM 150 can determine the operation that the user is seeking for a current conversation (e.g., update a user, etc.), referred to herein as a ‘user-facing function’ may be invoked toward the context interface system 120 (e.g., using a DirectFunctionCall(FunctionID) in order to trigger the context interface system 120 to perform the function identified by the FunctionID included in the DirectFunctionCall( ) private LLM function. Obtaining a DirectFunctionCall from the LLM 150 can also trigger the context interface system 120 to set the function corresponding to the identified FunctionID in the call to be set to a recently called function of the LLM 150.

Obtaining a DirectFunctionCall( ) from the LLM 150 can also cause the context interface system 120 to clear the conversation history for the current user conversation for the user 102, meaning that, the context interface system 120 clears its history of the user conversation inputs and responses and, for a future interaction with the LLM 150 for a subsequent user conversation input, the context interface system 120 may be requested by the LLM 150 (e.g., for subsequent conversation inputs receive from the user 102 for the current user session) to identify at least the user-facing function (other recently called functions may also be identified, depending on configuration) to the LLM 150 using a [recently called functions] prompt segment that identifies parameters of the recently called function(s) that was/were invoked by the LLM 150 toward the context interface system 120. Further, any function groups currently set as in-context for the user conversation up to this point can be cleared upon clearing the conversation history for the user 102.

In some embodiments, the LLM 150 may invoke a ‘SendUserResponse(Content)’ private LLM function towards the context interface system 120 in order to cause the context interface system 120 to send a natural language response to the user 102/user device for any natural language content included in the ‘Content’ of a SendUserResponse call obtained from the LLM 150. Obtaining a SendUserResponse call from the LLM 150 can also cause the context interface system 120 to determine that a previously invoked function called by the LLM 150 (privately or directly) received from the LLM 150 prior to receiving the SendUserResponse call was the user-facing function called by the LLM 150 for the current conversation input, meaning that the context interface system 120 is to clear its current conversation history for the user 102 and that the previously invoked function (at least a user-facing function, and potential other recently invoked functions, depending on configuration) is to be set as recently called function(s) of the LLM 150, which can be passed to the LLM 150 using a [recently called functions] prompt segment for a subsequent conversation input from the user 102/interaction with the LLM 150. Further, any function groups currently set as in-context for the user conversation up to this point can be cleared upon clearing the conversation history for the user 102.

These example private LLM functions are only a few of the many private LLM functions that may be configured for the context interface system 120, in order to help minimize context for LLM 150 function calling operations/interactions. It is to be understood that any other private LLM functions may be configured for the context interface system 120 and identified to the LLM 150 to facilitate various operations/interactions for system 100.

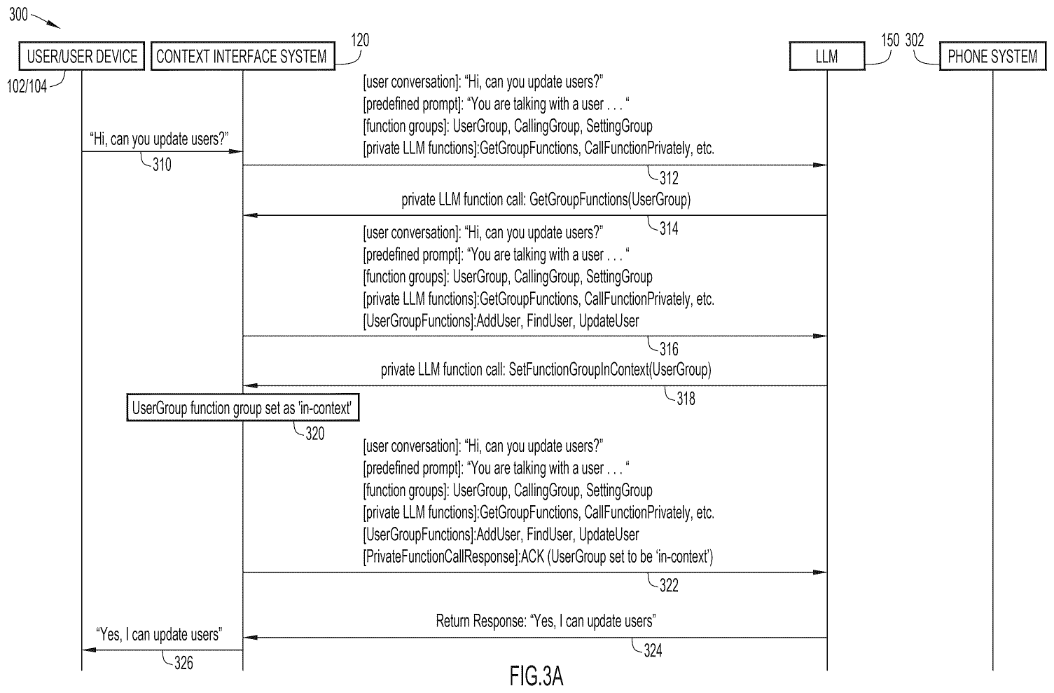

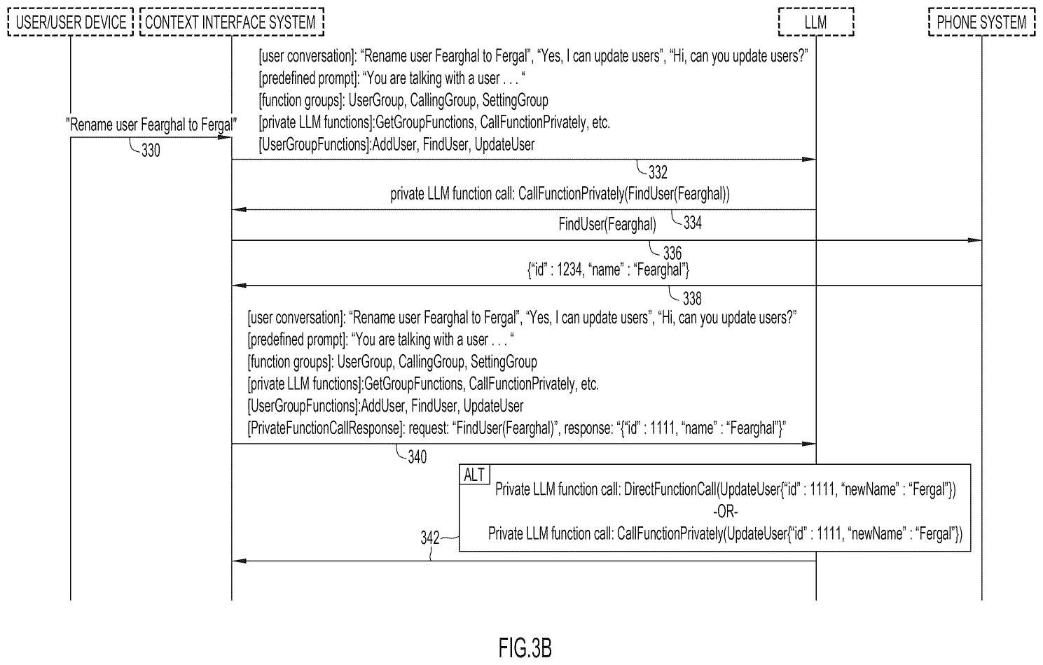

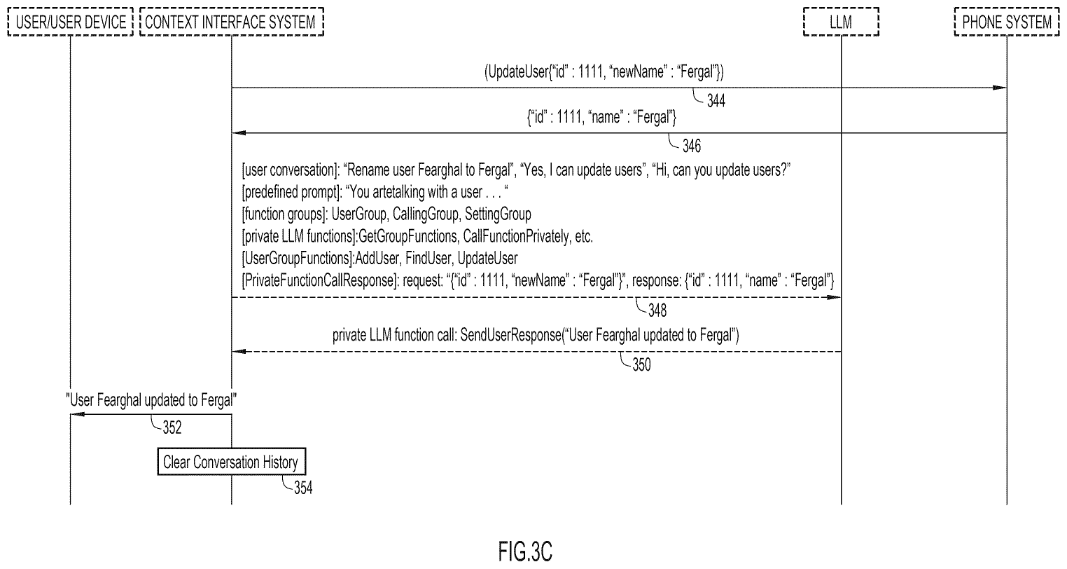

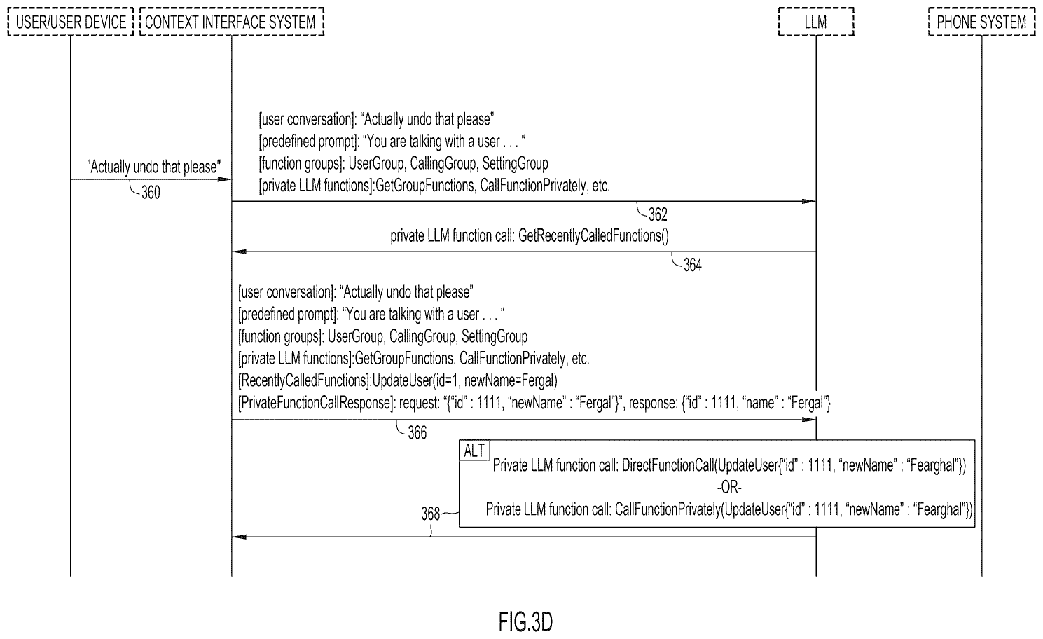

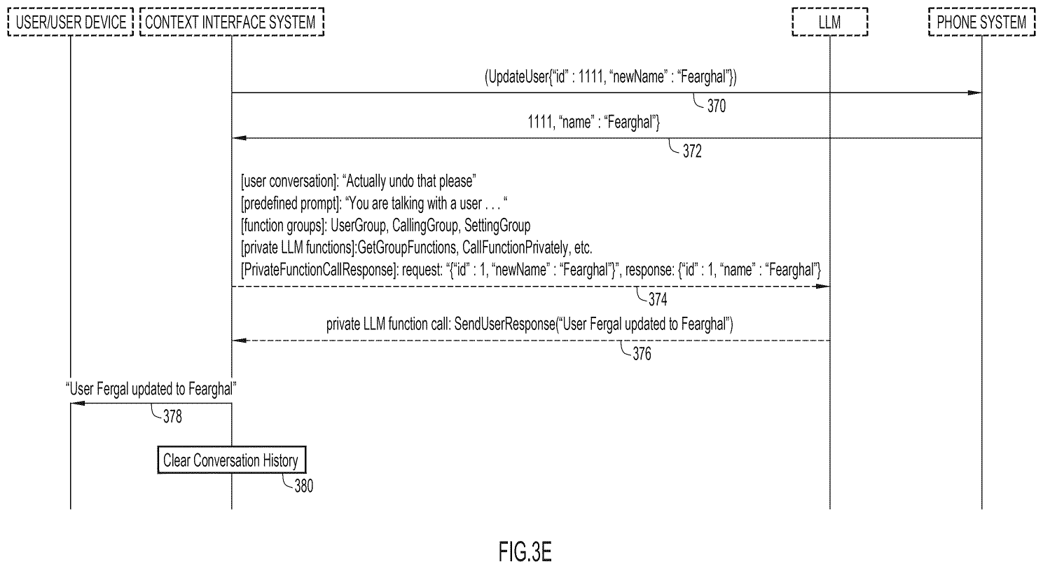

In order to further illustrate operations that may be performed via system 100 for a given user conversation, consider FIGS. 3A, 3B, 3C, 3D, and 3E which are a message sequence 300 diagram illustrating example operations that can be performed to minimize context for LLM function calling operations, according to an example embodiment. FIGS. 3A, 3B, 3C, 3D, and 3E include user 102/user device 104, context interface system 120, LLM 150, and a phone system 302 that, continuing from the operational example discussed above, can be managed by user 102/user device 104 via the context interface system 120. Certain example details of the message sequence diagram may refer to example details as provided for TABLE 1, above, and the nested tree structure 200 of the various top-level function groups, sub-function groups, and functions thereof, as provided for FIG. 2.

At 310, consider that a user conversation input is provided by the user 102/user device 104, such as “Hi, can you update users,” which is sent to the context interface system 120. Upon receiving the user conversation input (310), the context interface system 120 is triggered to send the LLM 150, as shown at 312, the following core prompt segments:
[user conversation]: updated/modified to identify the (natural language) user conversation input “Hi, can you update users?”;
[predefined prompt]: “You are talking with a user . . . ” [as noted in TABLE 1];
[function groups]: UserGroup, CallingGroup, SettingGroup [identifying the top-level domain functions as configured for the nested tree structure 200 of FIG. 2; and
[private LLM functions]: GetGroupFunctions, CallFunctionPrivately, etc. [as discussed above].

Upon receiving the prompt segments from the context interface system and interpreting/processing the user conversation input, the LLM 150 determines, from the UserGroup description included in the [function groups] prompt segment (e.g., UserGroup—“functions for managing users of the system”] that in order to facilitate updating a user (as requested by the user via the user conversation input), the LLM 150 needs more context/information regarding the UserGroup function group. Further, based on the description provided in the [private LLM functions] prompt segment, the LLM 150 determines that it is to call a private function in order to obtain more context/information regarding the UserGroup function group, specifically, that it is to perform a private LLM function call for the ‘GetGroupFunctions’ private LLM function in order to query and obtain further context for the UserGroup function group, as shown at 314 [GetGroupFunctions(UserGroup)].

Upon receiving the ‘GetGroupFunctions(UserGroup)’ private LLM function call, the context interface system 120 is triggered to provide a response to the LLM 150, as shown at 316, that includes, in addition to the core set of prompt segments, an [in-context functions] prompt segment describing the UserGroup functions as queried by the LLM 150, as follows:
[user conversation]: unchanged from 312;
[predefined prompt]: “You are talking with a user . . . ” [as noted in TABLE 1];
[function groups]: UserGroup, CallingGroup, SettingGroup [identifying the top-level domain functions as configured for the nested tree structure 200 of FIG. 2;
[private LLM functions]: GetGroupFunctions, CallFunctionPrivately, etc. [as discussed above]; and
[UserGroupFunctions]: AddUser, FindUser, UpdateUser [identifying each function and providing a description of each function of the UserGroup function group].

At this point, the LLM 150 is confident that it has identified/determined a function group and one or more functions that may be useful to the user and sets the UserGroup function group as the ‘in-context’ function group for the current user conversation, as shown at 318, via a private LLM function call ‘SetFunctionGroupInContext(UserGroup)’. This private function call to set the UserGroup function group as ‘in-context’ can trigger the context interface system 120 to set the context for the current user conversation to ‘UserGroup’, which has the effect of causing the context interface system 120 to set the UserGroup function group to be ‘in-context’, which has the effect of causing the context interface system 120 to add the UserGroup functions to further chats involving the user, until the current user conversation is cleared.

As a response to the private LLM function call, the context interface system 120 sends the LLM 150, as shown at 322, in addition to the core set of prompt segments, the [UserGroupFunctions] prompt segment, and a [PrivateFunctionCallResponse] prompt segment that includes an acknowledgement (ACK) that the UserGroup function group has been set for the context interface system 120 to be ‘in-context’, as follows:
[user conversation]: unchanged from 312;
[predefined prompt]: “You are talking with a user . . . ”;
[function groups]: UserGroup, CallingGroup, SettingGroup;
[private LLM functions]: GetGroupFunctions, CallFunctionPrivately, etc.;
[UserGroupFunctions]: AddUser, FindUser, UpdateUser; and
[PrivateFunctionCallResponse]: ACK

Upon receiving the response from the context interface system, the LLM 150 can generate a response to the user 102, such as “Yes, I can update users,” as shown at 324, which the context interface system 120 sends to the user device 104/user 102 as a user conversation output, as shown at 326.

Moving to FIG. 3B, consider that the user 102 sends an additional request, such as “Rename user Fearghal to Fergal,” as shown at 330. Upon receiving the user conversation input, the context interface system 120 determines to send to the LLM 150 the core set of prompt segments (with the [user conversation] prompt segment being updated to include the current conversation history for the user conversation: “Rename user Fearghal to Fergal”, “Yes, I can update users”, “Hi, can you update users?”), along with the ‘in-context’ functions prompt segment ([UserGroupFunctions], in this example), as shown at 332. Upon receiving the prompt segments, the LLM 150 determines that it needs additional context/information regarding the user ‘Fearghal’ identified in the user conversation input and invokes a private LLM function call for the FindUser function towards the context interface system 120, as shown at 334, such as ‘CallFunctionPrivately(FindUser(Fearghal))’.

Receiving the private function call at 334 triggers the context interface system 120 to perform the FindUser function towards the phone system 302, as shown at 336, to which the phone system responds with an identifier for the user Fearghal, as shown at 338 {“id”: 1111, “name” “Fearghal”}.

Upon receiving the FindUser response from the phone system 302, the context interface system 120 can send the LLM 150, as shown at 340, the core prompt segments, the ‘in-context’ function group, and a [PrivateFunctionCallResponse] prompt segment that identifies both request metadata or parameters of the function call for the corresponding FindUser function that were included in the private function call sent by the LLM 150 and response metadata identifying a result the one or more corresponding function operations performed for the corresponding FindUser function, as follows:
[PrivateFunctionCallResponse]: request: “FindUser(Fearghal)”, response: “{“id”: 1111, “name”: “Fearghal” }”

At this point, the LLM 150 determines that it is to invoke the UpdateUser function towards the context interface system 120 and that the UpdateUser function is the user-facing function invoked for the current user conversation. For example, the LLM 150 can determine that the UpdateUser function, when performed by the context interface system 120, will result in operation(s) being performed by the context interface system 120 that satisfy the request from the user 102 based on the current user conversation input, for example, to user information for the user “Fearghal” to be “Fergal.”

The LLM 150 can invoke the determined/identified user-facing function (UpdateUser, in this example) via the context interface system 120 using a variety of private LLM function calls, as shown at 342, in accordance with various embodiments herein, determining that an invoked function is a user-facing function can cause the context interface system 120 to subsequently clear its conversation history pertaining to the current conversation involving the user 102, and some embodiments, clear/remove any function groups currently set as in-context for the user conversation up to this point. Recall, the LLM 150 is stateless and, thus, does not store the user conversation.

In at least one embodiment, the LLM 150 may perform a DirectFunctionCall private LLM function call toward the context interface system 120 to trigger the context interface system 120 update the user corresponding to the user “id”: 1111 (currently user Fearghal, in this example) to be newly named “Fergal” (“newName”: “Fergal”).

In at least one embodiment, the LLM 150 may perform a CallFunctionPrivately private LLM function call towards the context interface system at 342 that includes similar information in order to trigger the context interface system 120 to update the user “Fearghal.”

In either embodiment, the UpdateUser function call initiated by the LLM 150 toward the context interface system 120 can trigger the context interface system 120 to perform UpdateUser operations toward the phone system 302, as shown at 344 of FIG. 3C, to which the phone system 302 responds with updated user information for the user “id”: 1111 to now be named “Fergal,” as shown at 346.

In at least one embodiment in which the DirectFunctionCall may be used to trigger the UpdateUser operations via the context interface system 120, the obtained updated user information can trigger a predefined natural language response to the user 102/user device 104 (e.g., a user conversation output), as shown at 352, such as “User Fearghal updated to Fergal.” Additionally, obtaining the DirectFunctionCall from the LLM 150 can also trigger the context interface system 120 to identify the UpdateUser function as the user-facing function that has been called for the current user conversation and, as such, can cause the context interface system 120 to set the UpdateUser function as at least one of the recently called function of the LLM 150 (in some embodiments, the previously called FindUser function could also be stored as a recently called function of the LLM 150).

Further, after invoking the DirectFunctionCall toward the context interface system 120 for the determined/identified user-facing function, the context interface system 120 can clear its conversation history for the current user 102 conversation, as shown at 354 including clearing any function groups currently set as in-context for the user conversation up to this point (e.g., removing/clearing the UserGroupFunctions as in-context).

Other operations/interactions can be performed between the context interface system 120 and the LLM 150 in order to trigger such a natural language response being sent to the user 102/user device 104.

For example, in some embodiments if the CallFunctionPrivately private LLM function is sent to the context interface system 120 (at 342) then, upon performing the invoked function operations, the context interface system 120 can send to the LLM 150, as shown at 348, the core set of prompt segments, the in-context functions prompt segment (e.g., [UserGroupFunctions]), and a [PrivateFunctionCallResponse] prompt segment including request and response metadata for the invoked UpdateUser function that was privately called by the LLM 150. In such an embodiment, the LLM 150 may further perform a SendUserResponse private LLM function call toward the context interface system 120, as shown at 350, including the content “User Fearghal updated to Fergal,” which can trigger the context interface system 120 to send the natural language response to the user 102/user device 104 at 354. Obtaining the SendUserResponse private function call from the LLM 150 can further cause the context interface system 120 to identify the previous privately called UpdateUser function as the user-facing function that has been called for the current user conversation and, as such, can cause the context interface system 120 to set the UpdateUser function as at least one of the recently called functions of the LLM 150 and to clear its conversation history for the user 102 and, in some embodiments, to also clear any function groups currently set as in-context for the user conversation up to this point (e.g., removing/clearing the UserGroupFunctions as in-context).

Other variations for triggering the natural language response to the user 102/user device 104 and setting a corresponding previously called function by the context interface system 120, as well as clearing the conversation history by the context interface system 120, and potentially clearing any function groups as being in-context, based on identification/determination of a corresponding user-facing function being invoked towards the context interface system 120 can be envisioned, for example, based on different private LLM functions and/or logic that may be configured for the context interface system 120. For instance, in some embodiments, the [PrivateFunctionCallResponse] prompt segment including the corresponding request and response metadata can be sent in conjunction with the DirectFunctionCall sent at 342. Further, the SendUserResponse private LLM function call toward the context interface system 120, as shown at 350, including the content “User Fearghal updated to Fergal” may also be used in combination with DirectFunctionCall operations/interactions in some embodiments.

Moving to FIG. 3D, consider additional operations/interactions with the LLM 150 that may be facilitated by the context interface system 120, for example, based on an additional user conversation input, such as “Actually, undo that please,” meaning that the user 102 is requesting to undo the previous user's name change (as provided via the operations of FIGS. 3B and 3C).

For FIG. 3D, it is understood by the context interface system 120 based on the previous interactions/operations of FIGS. 3B and 3C that the UpdateUser function is set to a recently called function of the LLM and that, for any subsequent user conversation inputs received from the user 102/user device 104, the [user conversation] prompt segment sent to the LLM 150 is to be reset.

For example, as shown at 360, consider that the user 102 decides to undo the name change of the user “Fergal” (e.g., the user's name should instead be identified as “Fearghal”) and, as such, sends a conversation input of “Actually undo that please” to the context interface system 120. Obtaining the user conversation input triggers the context interface system 120 to send to the LLM 150, as shown at 362, the core set of prompt segments (with the [user conversation] prompt segment set to “Actually undo that please”). Recall, determining that a user-facing function has been called and clearing the conversation history by the context interface system 120 can also trigger the context interface system to clear any ‘in-context’ functions, such as the UserGroupFunctions in this example, such that the ‘in-context’ functions prompt segment [UserGroupFunctions] is not sent to the LLM at 362.

Upon obtaining the prompt segments, the LLM 150 determines that it does not have sufficient context with regard to what it is supposed to undo, but does know, based on the private LLM function, GetRecentlyCalledFunctions( ), that is described to the LLM 150 via the [private LLM functions] prompt segment, that the LLM 150 can query the context interface system 120, as shown at 364, in order to obtain the recently called functions that it has called towards the context interface system 120 and, thus, obtain more context therefrom.

In response to receiving the GetRecentlyCalledFunctions( ) call from the LLM 150, the context interface system 120 passes to the LLM 150, as shown at 366, the core set of prompt segments, and a [RecentlyCalledFunctions] prompt segment identifying the recently called UpdateUser function, along with the parameters of the recently called function. In some embodiments, the context interface system 120 can also include a [PrivateFunctionCallResponse] prompt segment including the corresponding request and response parameters of the recently called function. In some instances, the LLM 150 may trigger the context interface system 120 to set the UserGroupFunctions back to be in-context, as discussed above at 318.

Upon obtaining the additional context from the context interface system 120, the LLM 150 can now confidently determine that it is to trigger an UpdateUser function call towards the context interface system 120 (and, similarly, that the UpdateUser function is considered to be the user-facing function invoked for the current user conversation) and can perform a private LLM function call towards the context interface system 120 using any of the mechanisms, as discussed above for FIGS. 3B and 3C, in order to invoke the UpdateUser function towards the context interface system, as shown at 368.

Moving to FIG. 3E, the UpdateUser function call initiated by the LLM 150 toward the context interface system 120 can trigger the context interface system 120 to perform UpdateUser operations toward the phone system 302, as shown at 370, to which the phone system 302 responds with updated user information for the user “id”: 1111 to now be named “Fearghal,” as shown at 372.

Various interactions can be sent between the LLM 150 and the context interface system at 374 and 376 (similar to those discussed above at 348 (without passing the UserGroupFunctions to the LLM as in-context unless re-set to be in-context by the LLM) and 350) in various embodiments.

The context interface system 120, can provide a natural response to the user 102/user device 104, as shown at 378, such as “User Fergal updated to Fearghal.” Additionally, the context interface system 120 can re-mark the UpdateUser function as called at 368 and parameters associated therewith as a recently called function for the user conversation (for any subsequent exchanges involving the user 102 and the LLM 150). Further, based on determining/identifying the UpdateUser function as the user-facing function for the current user conversation, the context interface system 120 can clear its conversation history, as shown at 380 and can clear its conversation history for the user 102, including clearing any function groups currently set as in-context for the user conversation up to this point (e.g., removing/clearing the UserGroupFunctions as in-context).

In some embodiments, the context interface system 120 can clear any recently called functions 134 (and any metadata stored therewith) and function groups in-context (and any metadata stored therewith) that may be stored via 132 and 134 of storage 130 after a configurable period of time, after a configurable number of functions have been called, combinations thereof, and/or the like.

Thus, as illustrated through FIGS. 3A, 3B, 3C, 3D, and 3E the context interface system 120 may facilitate minimizing the context and token usage by the LLM 150 through the use of the core set of prompt segments that can be sent to the LLM 150 for each interaction with the LLM 150, and the use of additional prompt segments that can be selectively passed to the LLM 150, for example, when additional context is requested/queried by the LLM 150. The various elements outlined for system 100 are combined to provide unique techniques for reducing invalid responses of the LLM 150, while retaining the ability for natural conversation elements of an end user that seeks specific context to be retained.

Although the conversations illustrated for FIGS. 3A, 3B, 3C, 3D, and 3E is illustrative of usage of the context interface system 120, the example operations/interactions may not show additional checks and balances that could be implemented for system 100, but rather illustrates how the context interface system 120 allows for minimal context to be passed to the LLM 150 such as to reduce the token usage that would be otherwise required for such a system. It is to be understood that additional operations may be implemented for the system 100 in order to handle specific scenarios, such as long conversations before a function may be called, etc. For example, in scenarios that may involve long conversations before a function is called, a summary of a given conversation may be used to reduce the scope passed to the LLM 150 by the context interface system 120.

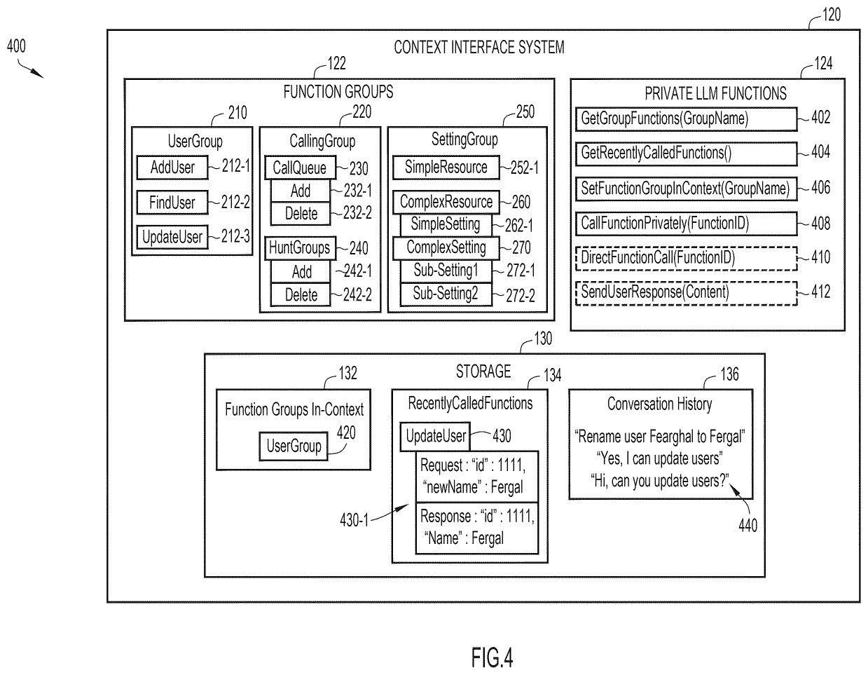

Referring to FIG. 4, FIG. 4 is a block diagram 400 illustrating example details of various function groups, functions, and data that can be configured and/or maintained/stored by the context interface system 120, in accordance with embodiment herein. For example, FIG. 4 illustrates various the function groups 122 and private LLM functions 124 that may be configured for the context interface system 120 to facilitate the various operations/interactions as discussed above with reference to FIGS. 3A, 3B, 3C, 3D, and 3E.

For example, as shown in FIG. 4, the function groups 122 may be configured with the top-level function groups, such as the UserGroup 210, the CallingGroup 220, and the SettingGroup 250 in which each function group can include its corresponding functions callable by the LLM 150 and, if applicable, sub-function groups/functions configured therefore, as discussed above with reference to FIG. 2.

Further, various private LLM functions 124 callable by the LLM 150 can also be configured for the context interface system 120. For example, a GetGroupFunctions private LLM function (402) can be configured, which the LLM 150 can call in order to obtain additional context for a given function group/sub-function group from the context interface system 120, as discussed for various embodiments herein. Further, a GetRecentlyCalledFunctions private LLM function (404) can be configured, which the LLM 150 can call in order to obtain additional context for any function(s) recently called by the LLM 150 towards the context interface system, as discussed for various embodiments herein.

Additionally, a SetFunctionGroupInContext private LLM function (406) can also be configured, which the LLM 150 can call in order to set a particular function group (or sub-function group) to be ‘in-context’ for a given user conversation, as discussed for various embodiments herein. Additionally, a CallFunctionPrivately private LLM function (408) can also be configured, which the LLM 150 can use to invoke/call a given function to be performed by the context interface system, as discussed for various embodiments herein.

Other private LLM functions may be configured for the context interface system 120. In some embodiments, a DirectFunctionCall private LLM function (410) can be configured in which the LLM 150 can use the DirectFunctionCall to call a function towards the context interface system 120 that the LLM 150 has identified/determined to be a user-facing function (operation(s)/action(s) that a user is seeking from the LLM 150) for a given user conversation. Use of the DirectFunctionCall towards the context interface system 120 can indicate that the context interface system 120 is to clear its conversation history for the current user conversation following execution of the function called.

In some embodiments, a SendUserResponse private LLM function (412) can be configured in which the LLM 150 can send a SendUserResponse call towards the context interface system 120 in order to cause the context interface system 120 to send a natural language response to the user 102/user device for any natural language content included in the ‘Content’ of the SendUserResponse call obtained from the LLM 150. Obtaining a SendUserResponse call from the LLM 150 can also cause the context interface system 120 to determine that a previously invoked function called by the LLM 150 (privately or directly) was the user-facing function called by the LLM 150 for the current conversation input, meaning that the current conversation history for the user 102 is to be cleared by the context interface system 120, that the context interface system 120 may clear any function groups in-context, and that the previously invoked function (at least a user-facing function, and potential other recently invoked functions, depending on configuration) is to be set as a recently called function of the LLM 150, which can be passed to the LLM 150 using a [recently called functions] prompt segment for a subsequent conversation input from the user 102/interaction with the LLM 150.

As discussed for various embodiments herein, various data/information can also be stored by the context interface system 120 via storage 130 through various operations/interactions with the LLM 150. Considering the interactions as illustrated/discussed for FIG. 3A, for example, as shown at 320 of FIG. 3A, the context interface system 120 can set/store the UserGroup (210) as the ‘in-context’ function group for the current user conversation, as generally illustrated at 420 of FIG. 4.

Further, considering the interactions as illustrated/discussed for FIG. 3C, for example, after performing the UpdateUser function operations (as called by the LLM 150) as generally shown at 342, 344, and 346 of FIG. 3C, the context interface system 120 can also store the UpdateUser function, as generally illustrated at 430 of FIG. 4, and request/response metadata associated therewith, as generally illustrated at 430-1 of FIG. 4, as a recently called function of the LLM 150. Additionally, the user conversation history for the user conversation can also be stored by the context interface system 120, as generally illustrated at 440 of FIG. 4. The user conversation history and, in some embodiments, the function groups in-context can be cleared by the context interface system 120 upon determining that a user-facing function has been called towards the context interface system 120 by the LLM 150.

Thus, various function group/functions that may be callable by the LLM 150 and various data/information can be maintained by the context interface system 120 in order to minimize the context and token usage of the LLM 150 through a user conversation.

It is to be understood that the example prompts/prompt segments as discussed for embodiments herein may include several variations and forms and are not limited to the specific forms as discussed for the example operations of FIGS. 3A, 3B, 3C, 3D, and 3E. In various embodiments, the prompt segment language configured for interactions with an LLM may be obtained by generating various candidate prompt segments for different desired use cases, scenarios, and/or database(s)/system(s) with which the context interface system 120 is to interact, manage, etc. (e.g., a phone system, product support system, a customer conflict resolution system, etc.) and determining metrics based on the output of a given LLM relative to desired or known results. Determining prompt segment language achieving greatest accuracy, performance, compliance, and/or other criteria may be used for configuring different prompt segments that can be provided to the LLM. In this way, different prompt segments may be updated to adjust operation or behavior of various LLMs and/or databases/systems with which the context interface system 120 interacts, manages, etc. in order to improve performance or compliance, or to perform different tasks or behaviors.

Further, it is to be understood that any function groups, sub-function groups, and (terminating) functions may be configured for any number of nested tree structure(s) for the context interface system 120 in order to facilitate any management, interaction, etc. operations with/for any database(s)/system(s) with which the context interface system 120 may interface/communicate.

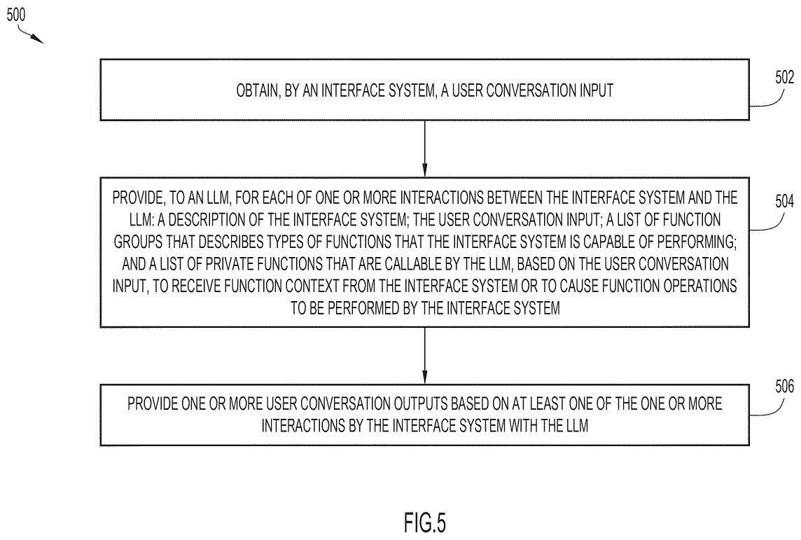

Referring to FIG. 5, FIG. 5 is a flow chart depicting a method 500 according to an example embodiment. In at least one embodiment, method 500 illustrates operations that may be performed by a context interface system, such as context interface system 120 of FIG. 1 in order to minimize context for an LLM for various function calling operations/interactions between the context interface system and the LLM.

As shown at 502, the method may include obtaining, by an interface system, a user conversation input.

At 504, the method may include providing, to an LLM, for each of one or more interactions between the interface system and the LLM: a description of the interface system; the user conversation input; a list of function groups that describes types of functions that the interface system is capable of performing; and a list of private functions that are callable by the LLM, based on the user conversation input, to receive function context from the interface system or to cause function operations to be performed by the interface system.

At 506, the method may include providing one or more user conversation outputs based on at least one of the one or more interactions by the interface system with the LLM.

Each function group can include one or more functions that the LLM is capable of invoking to cause the interface system to perform one or more function operations based on the user conversation input. Each of the one or more functions of each function group are not provided to the LLM unless requested by the LLM.

For instance, although not shown in FIG. 5, additional information may be provided to the LLM by the interface system, for example, based on different interactions performed by the LLM towards the interface system.

In at least one instance, one private function identified in the list of private functions can include a function group query that enables the LLM to obtain, from the interface system, function context for a particular function group identified in a particular function group query.

In at least one embodiment, upon receiving a corresponding function query by the interface system from the LLM that identifies a corresponding function group, the method may include providing to the LLM: the description of the interface system; the user conversation input; the list of function groups that describes functions that the interface system is capable of performing; the list of private functions that are callable by the LLM; and the function context for the corresponding function group. The function context for the corresponding function group can include at least one of: a list of functions of the particular function group that are available to the LLM for causing the interface system to perform one or more operations based on the user conversation input; or a list of one or more sub-function groups of the corresponding function group.

In at least one instance, one private function identified in the list of private functions is a function call that enables the LLM to invoke a particular function of a particular function group to cause the interface system to perform particular function operations for the particular function. In at least one embodiment, upon receiving a corresponding function call by the interface system from the LLM that identifies a corresponding function, the method may further include performing one or more corresponding function operations for the corresponding function. In at least one embodiment, the method may further include providing to the LLM: the description of the interface system; the user conversation input; the list of function groups that describes functions that the interface system is capable of performing; the list of private functions that are callable by the LLM; and first data identifying parameters of the function call for the corresponding function obtained from the LLM and second data identifying a result of the one or more corresponding function operations performed for the corresponding function. In at least one embodiment, at least one user conversation output is obtained by the interface system from the LLM based on the one or more corresponding function operations performed for the corresponding function.

In one instance, one private function identified in the list of private functions is a recent functions query that enables the LLM to request from the interface system a list of functions called by the LLM towards the interface system.

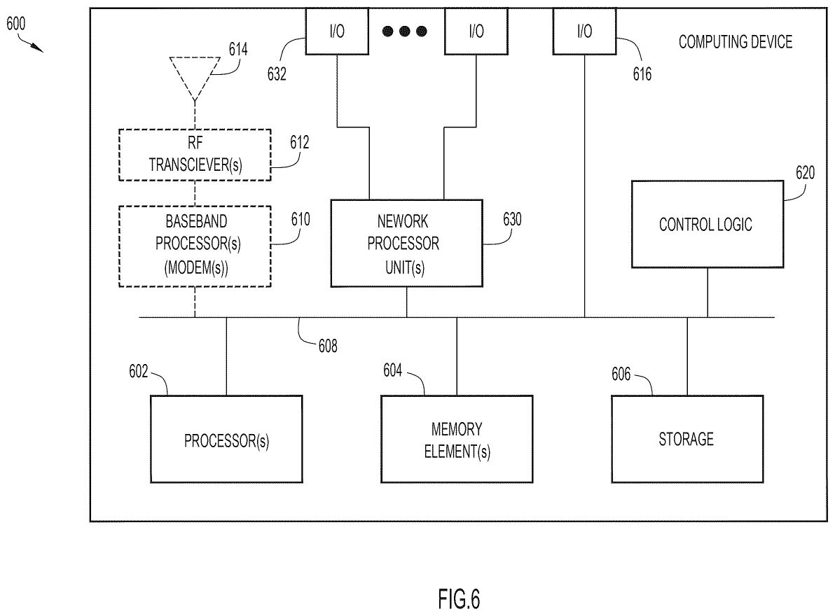

Referring to FIG. 6, FIG. 6 illustrates a hardware block diagram of a computing device 600 that may perform functions associated with operations discussed herein in connection with the techniques described for embodiments herein. In various embodiments, a computing device or apparatus, such as computing device 600 or any combination of computing devices 600, may be configured as any entity/entities in order to perform operations of the various techniques discussed for embodiments herein, such as any elements, functions, etc. discussed for embodiments herein.

In at least one embodiment, the computing device 600 may be any apparatus that may include one or more processor(s) 602, one or more memory element(s) 604, storage 606, a bus 608, one or more network processor unit(s) 630 interconnected with one or more network input/output (I/O) interface(s) 632, one or more I/O interface(s) 616, and control logic 620. In various embodiments, instructions associated with logic for computing device 600 can overlap in any manner and are not limited to the specific allocation of instructions and/or operations described herein.

For embodiments in which computing device 600 may be implemented as any device capable of wireless communications, computing device 600 may further include at least one baseband processor or modem 610, one or more radio RF transceiver(s) 612 (e.g., any combination of RF receiver(s) and RF transmitter(s)), one or more antenna(s) or antenna array(s) 614.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 630 may enable communication between computing device 600 and other systems, entities, etc., via network I/O interface(s) 632 (wired and/or wireless) to facilitate operations discussed for various embodiments described herein. In various embodiments, network processor unit(s) 630 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 632 can be configured as one or more Ethernet port(s), Fibre Channel ports, any other I/O port(s), and/or antenna(s)/antenna array(s) now known or hereafter developed. Thus, the network processor unit(s) 630 and/or network I/O interface(s) 632 may include suitable interfaces for receiving, transmitting, and/or otherwise communicating data and/or information (wired and/or wirelessly) in a network environment.

I/O interface(s) 616 allow for input and output of data and/or information with other entities that may be connected to computing device 600. For example, I/O interface(s) 616 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

For embodiments in which computing device 600 is implemented as a wireless device or any apparatus capable of wireless communications, the RF transceiver(s) 612 may perform RF transmission and RF reception of wireless signals via antenna(s)/antenna array(s) 614, and the baseband processor or modem 610 performs baseband modulation and demodulation, etc. associated with such signals to enable wireless communications for computing device 600.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may facilitate minimizing context for LLM function calling operations. In one form, a computer-implemented method is provided that may include obtaining, by an interface system, a user conversation input; providing, to an LLM, for each of one or more interactions between the interface system and the LLM: a description of the interface system; the user conversation input; a list of function groups that describes types of functions that the interface system is capable of performing; and a list of private functions that are callable by the LLM, based on the user conversation input, to receive function context from the interface system or to cause function operations to be performed by the interface system; and providing one or more user conversation outputs based on at least one of the one or more interactions by the interface system with the LLM.

Each function group can include one or more functions that the LLM is capable of invoking to cause the interface system to perform one or more function operations based on the user conversation input. Each of the one or more functions of each function group are not provided to the LLM unless requested by the LLM.

Additional information may be provided to the LLM by the interface system, for example, based on different interactions performed by the LLM towards the interface system.

In at least one instance, one private function identified in the list of private functions can include a function group query that enables the LLM to obtain, from the interface system, function context for a particular function group identified in a particular function group query.

In at least one embodiment, upon receiving a corresponding function query by the interface system from the LLM that identifies a corresponding function group, the method may include providing to the LLM: the description of the interface system; the user conversation input; the list of function groups that describes functions that the interface system is capable of performing; the list of private functions that are callable by the LLM; and the function context for the corresponding function group. The function context for the corresponding function group can include at least one of: a list of functions of the particular function group that are available to the LLM for causing the interface system to perform one or more operations based on the user conversation input; or a list of one or more sub-function groups of the corresponding function group.

In at least one instance, one private function identified in the list of private functions is a function call that enables the LLM to invoke a particular function of a particular function group to cause the interface system to perform particular function operations for the particular function. In at least one embodiment, upon receiving a corresponding function call by the interface system from the LLM that identifies a corresponding function, the method may further include performing one or more corresponding function operations for the corresponding function. In at least one embodiment, the method may further include providing to the LLM: the description of the interface system; the user conversation input; the list of function groups that describes functions that the interface system is capable of performing; the list of private functions that are callable by the LLM; and first data identifying parameters of the function call for the corresponding function obtained from the LLM and second data identifying a result of the one or more corresponding function operations performed for the corresponding function. In at least one embodiment, at least one user conversation output is obtained by the interface system from the LLM based on the one or more corresponding function operations performed for the corresponding function.

In one instance, one private function identified in the list of private functions is a recent functions query that enables the LLM to request from the interface system a list of functions called by the LLM towards the interface system.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z ‘ and’X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and’ one or more of can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by an interface system, a user conversation input;
providing, to a large language model (LLM), for each of one or more interactions between the interface system and the LLM:
a description of the interface system;
the user conversation input;
a list of function groups that describes types of functions that the interface system is capable of performing; and
a list of private functions that are callable by the LLM, based on the user conversation input, to receive function context from the interface system or to cause function operations to be performed by the interface system; and
providing one or more user conversation outputs based on at least one of the one or more interactions by the interface system with the LLM.

2. The method of claim 1, wherein each function group includes one or more functions that the LLM is capable of invoking to cause the interface system to perform one or more function operations based on the user conversation input.

3. The method of claim 2, wherein the one or more functions of each function group are not provided to the LLM unless requested by the LLM.

4. The method of claim 1, wherein one private function identified in the list of private functions is a function group query that enables the LLM to obtain, from the interface system, function context for a particular function group identified in a particular function group query.

5. The method of claim 4, further comprising:
upon receiving a corresponding function query by the interface system from the LLM that identifies a corresponding function group, providing to the LLM:
the description of the interface system;
the user conversation input;
the list of function groups that describes functions that the interface system is capable of performing;
the list of private functions that are callable by the LLM; and
the function context for the corresponding function group.

6. The method of claim 5, wherein the function context for the corresponding function group is at least one of:
a list of functions of the particular function group that are available to the LLM for causing the interface system to perform one or more operations based on the user conversation input; or
a list of one or more sub-function groups of the corresponding function group.

7. The method of claim 1, wherein one private function identified in the list of private functions is a function call that enables the LLM to invoke a particular function of a particular function group to cause the interface system to perform particular function operations for the particular function.

8. The method of claim 7, further comprising:
upon receiving a corresponding function call by the interface system from the LLM that identifies a corresponding function:
performing one or more corresponding function operations for the corresponding function.

9. The method of claim 8, further comprising:
providing to the LLM:
the description of the interface system;
the user conversation input;
the list of function groups that describes functions that the interface system is capable of performing;
the list of private functions that are callable by the LLM; and
first data identifying parameters of the function call for the corresponding function obtained from the LLM and second data identifying a result of the one or more corresponding function operations performed for the corresponding function.

10. The method of claim 8, wherein at least one user conversation output is obtained by the interface system from the LLM based on the one or more corresponding function operations performed for the corresponding function.

11. The method of claim 1, wherein one private function identified in the list of private functions is a recent functions query that enables the LLM to request from the interface system a list of functions called by the LLM towards the interface system.

12. The method of claim 1, wherein the user conversation input sent to the LLM includes one or more previous user conversation inputs obtained by the interface system.

13. One or more non-transitory computer readable storage media encoded with instructions that, when executed by a processor, cause the processor to perform operations, comprising:
obtaining, by an interface system, a user conversation input;
providing, to a large language model (LLM), for each of one or more interactions between the interface system and the LLM:
a description of the interface system;
the user conversation input;
a list of function groups that describes types of functions that the interface system is capable of performing; and
a list of private functions that are callable by the LLM, based on the user conversation input, to receive function context from the interface system or to cause function operations to be performed by the interface system; and
providing one or more user conversation outputs based on at least one of the one or more interactions by the interface system with the LLM.

14. The media of claim 13, wherein each function group includes one or more functions that the LLM is capable of invoking to cause the interface system to perform one or more function operations based on the user conversation input.

15. The media of claim 14, wherein the one or more functions of each function group are not provided to the LLM unless requested by the LLM.

16. The media of claim 13, wherein one private function identified in the list of private functions is a function call that enables the LLM to invoke a particular function of a particular function group to cause the interface system to perform particular function operations for the particular function.

17. An interface system comprising:
at least one memory element for storing data; and
at least one processor for executing instructions associated with the data, wherein executing the instructions causes the interface system to perform operations, comprising:
obtaining, by an interface system, a user conversation input;
providing, to a large language model (LLM), for each of one or more interactions between the interface system and the LLM:
a description of the interface system;
the user conversation input;
a list of function groups that describes types of functions that the interface system is capable of performing; and
a list of private functions that are callable by the LLM, based on the user conversation input, to receive function context from the interface system or to cause function operations to be performed by the interface system; and
providing one or more user conversation outputs based on at least one of the one or more interactions by the interface system with the LLM.

18. The interface system of claim 17, wherein each function group includes one or more functions that the LLM is capable of invoking to cause the interface system to perform one or more function operations based on the user conversation input.

19. The interface system of claim 18, wherein the one or more functions of each function group are not provided to the LLM unless requested by the LLM.

20. The interface system of claim 18, wherein the user conversation input sent to the LLM includes one or more previous user conversation inputs obtained by the interface system.
